(19) United States
(12) Patent Application Publication
(10) Pub. No.: US 2012/0314309 A1
(43) Pub. Date: Dec. 13, 2012

(54) Image-Capturing Lens Unit

(76) Inventors: Keisuke Tatebayashi, Hino-shi (JP); Kenichi Iwaida, Hachioji-shi (JP)

(21) Appl. No.: 13/579,499

(22) PCT Filed: Dec. 24, 2010
(86) PCT No.: PCT/JP2010/073317

§ 371 Date: Aug. 16, 2012

(30) Foreign Application Priority Data
Feb. 19, 2010 (JP) 2010-035063
Apr. 7, 2010 (JP) 2010-088491

(51) Int. Cl. G02B 7/02

(52) U.S. Cl. 359/819

(57) ABSTRACT

An image-capturing lens (OU) can be positioned in the optical axis direction by causing a flange section of the image-capturing lens (OU) and a contact section (42a) of a barrel frame (40) to make contact with each other. Also, the image-capturing lens (OU) can be positioned in the direction intersecting the optical axis direction by causing a part of the entire circumference of the optical surface (S1) of the image-capturing lens (OU) to make contact with the opening (43) of the barrel frame (40). As a result, the light receiving surface of an image sensor (51) can be accurately positioned at the focal point of the image-capturing lens (OU) only by placing the barrel frame (40) on a base plate (52).

### TECHNICAL FIELD

The present invention relates to an image-capturing lens unit, and further to a compact image-capturing lens unit suitable for mass production.

### BACKGROUND ART

Compact and very thin image-capturing devices (hereafter also called camera module) have been mounted on mobile terminals which are compact and thin electronic devices such as mobile phones and PDA (Personal Digital Assistant). As an image sensor used for these image-capturing devices, solid-state image sensing devices, such as a CCD type image sensor and a CMOS type image sensor, are known. In recent years, an increase of the pixel numbers of the image sensor is progressing and high resolution and high performance have been attained. As an image-capturing lens unit used for the image-capturing device built in such a personal digital assistant, there are some which are shown in the patent document 1.

According to the patent document 1, the image-capturing lens 11 is attracted from the opening of lens frame for entering photographic subject light by operating a vacuum pump. With this attraction, the end surface of the 4th lens is attracted to the object side and further the 1st lens that has been pressed by the 4th lens, the shielding member, the 2nd lens, the shielding member, the 3rd member, and the shielding member move to the object side and the front end portion of the 1st lens contacts the inner wall of the lens frame. It is possible to perform an accurate attachment by bonding in such condition.

### PRIOR ART DOCUMENTS

### Patent Documents

Patent document 1: Unexamined Japanese Patent Application Publication No. 2008-145929

### BRIEF DESCRIPTION OF THE INVENTION

### Problems to be Solved by the Invention

In the image-capturing lens unit of the patent document 1, since the outline of the flange of the lens is a cylinder surface, a contact of the cylinder surfaces can perform positioning of a lens and a lens frame in a direction perpendicular to the optical axis with high precision. By the way, these days, in order to mass-produce an image-capturing lens, a method of obtaining a lens is developed in which two or more lenses are formed in the shape of a wafer, and each lens is obtained by cutting out from the wafer. According to this process, although a plurality of lenses can be once manufactured by fabrication, since the accuracy of a logging part is based on the accuracy of machining, it is less than the accuracy of the circular flange part of the lens formed by molding. Therefore, there is a problem how to fix to lens frame the lens cut down in this way with sufficient accuracy.

This invention is made in view of the problem of this conventional technology, and aims at offering the image-capturing lens unit which can fix the image-capturing lens that can be mass-produced simply with sufficient accuracy to lens frame.

### Means to Solve the Problems

An image-capturing lens unit of claim 1 comprises: an image-capturing lens; and a lens flame which holds the image-capturing lens, wherein the image-capturing lens includes an optical surface and a flange part formed on a periphery of the optical surface, at least a part of a circumference of the flange section has been cut; and the lens frame includes a first contact portion for positioning in an optical axis direction of the image-capturing lens by contacting to the flange part, and a second contact portion for positioning in a direction intersecting the optical axis by contacting to a part of a whole circumference of the optical surface or a part of a whole circumference of an inclined surface formed concentrically with respect to the optical axis on the flange part.

According to the present invention, by contacting the flange part with the first contact portion of the lens frame, a positioning of the image-capturing lens in an optical axis direction can be realized and by contacting a part of a whole circumference of the optical surface of the image-capturing lens or a part of a whole circumference of an inclined surface formed concentrically with respect to the optical axis on the flange part, a positioning of the image-capturing lens in a direction intersecting the optical axis direction can be realized. Therefore, even if the accuracy of the outer shape of the flange part is bad, the optical surface of the above-mentioned image-capturing lens can be positioned with high precision to the above-mentioned lens frame. Here, as a position of the lens to which the second contact portion contacts, a lens surface portion around which the effective lens surface where the light flux to be used for imaging on the image-capturing element and a taper surface formed around the effective lens surface for the purpose of the contact are favorable. Such surfaces can be formed concentrically with respect to the optical axis of the lens accurately by forming at a same time when molding a lens using a mold. And the taper surface formed on the flange part concentrically with respect to the optical axis can be formed concentrically with respect to the optical axis of the lens accurately by forming at a same time when molding a lens using a mold.

The image-capturing lens unit of claim 2 is characterized in that, in the invention described in claim 1, the flange part of the image-capturing lens has a rectangle shape. Thereby, the above-mentioned image-capturing lens can be cut efficiently by using the cutter which cuts in the shape of a straight line.

The image-capturing lens unit of claim 3 is characterized in that, in the invention described in claim 1 or 2, a roughened surface is formed on at least a part of an inner periphery surface of the lens frame.

With the configuration of the flange part of the image-capturing lens of which the outer periphery has been cut, there is a possibility that a comparatively big gap between the image-capturing lens and the lens frame is produced. In this case, the light reflected in respect of the inner circumference of lens frame serves as a ghost, it enters into the light receiving surface of the above-mentioned image sensor, and there is a possibility of spoiling the quality of image of a picture. On the other hand, according to this invention, a generation of a ghost is controlled by forming a roughened surface on at least a part of the inner circumference surface of the above-mentioned lens frame. In addition, the roughened surface is a surface having surface roughness Ra of 1 μm more.

The image-capturing lens unit of claim 4 is characterized in that, in the invention described in claim 3, the lens frame is formed by molding using a mold and a transfer surface of the mold for transferring the roughened surface has been subjected to a blast processing. Thereby, the roughened surface can be formed on the inner periphery surface of the above-mentioned lens frame efficiently.

The image-capturing lens unit of claim 5 is characterized in that, in the invention described in any one of claims 1 to 4, the lens frame is formed integrally of a peripheral wall and a top wall which covers one end surface of the peripheral wall; the image-capturing lens and the lens frame are formed to be fixed by using an adhesive pasted on the peripheral wall; and a capturing part for capturing an adhesive is provided on the top wall. Contamination of the optical surface by adhesives etc. is controlled by capturing excessive adhesives in the above-mentioned capturing part.

The image-capturing lens unit of claim 6 is characterized in that, in the invention described in any one of claims 1 to 5, the lens frame includes a communicating portion to enable an air to pass between an inside and an outside of the lens frame. For example, when a reflow processing is utilized at a time of mounting an image-capturing device in a substrate etc., the image-capturing device shall pass the reflow furnace inside of which becomes 200-300 degrees C. And when the image-capturing device is sealed at this time, there is a possibility of internal air expanding and destroying lens frame etc. On the other hand, by providing a communicating portion like this invention, air inside and outside communicate through this communicating portion, and thereby internal air expanding and destroying lens frame can be controlled.

The image-capturing lens unit of claim 7 is characterized in that, in the invention described in claim 6, the communicating portion comprises a notch provided on a site of the lens frame to which an optical element to be provided on a side where an image-capturing element of the image-capturing lens is provided is fixed. Thereby, communication of the gas from the bottom side of an image-capturing device is securable.

The image-capturing lens unit of claim 8 is characterized in that, in the invention described in claim 7, the optical element has a rectangle shape and a pair of the notches is provided on two places in a diagonal direction of the optical element. Thereby, communication of air can be secured even when the above-mentioned image sensor is moved and fixed to one notch.

The image-capturing lens unit of claim 9 is characterized in that, in the invention described in claim 6, the communicating portion is a notch formed on the contact portion which contacts the flange part in the optical axis direction. Thereby, communication of the gas from the bottom side of an image-capturing device is securable.

The image-capturing lens unit of claim 10 is characterized in that, in the invention described in any one of claims 1 to 9, the imaging-lens is attached to the lens frame through a shielding member. Thereby, the above-mentioned image-capturing lens can be easily fixed.

### Effects of the Invention

According to the present invention, it is possible to provide an image-capturing lens unit which can fix the image-capturing lens, which can be mass-produced simply, to the lens frame with sufficient accuracy.

### BRIEF DESCRIPTION OF THE DRAWINGS

FIG. 1 is a diagram showing molding steps of an image-capturing lens using a mold.

FIG. 2 is a diagram showing molding step of an image-capturing lens using a mold.

FIG. 3 is a diagram showing molding step of an image-capturing lens using a mold.

FIG. 4 is a perspective diagram on the front side of 1st glass lens array IM1.

FIG. 5 is a perspective diagram on the back side of 1st glass lens array IM1.

FIG. 6 is a perspective diagram on the front side of 2nd glass lens array IM2.

FIG. 7 is a perspective diagram on the back side of 2nd glass lens array IM2.

FIG. 8 is a diagram showing a part of a jig JZ holding the back of 1st glass lens array IM1 or 2nd glass lens array IM2.

FIG. 9 is a diagram showing a step of forming 3rd glass lens array IM3.

FIG. 10 is a diagram showing a step of forming 3rd glass lens array IM3.

FIG. 11 is a diagram showing a step of forming 3rd glass lens array IM3.

FIG. 12 is a perspective diagram showing a image-capturing lens unit obtained from the 3rd glass lens array IM3.

FIG. 13 is a diagram showing a step of molding a lens frame.

FIG. 14 is a diagram of the lens frame 40 viewed from the direction of the arrow XIV in FIG. 13.

FIG. 15 is a diagram of the lens frame 40 cut by XV-XV line, and viewed from the direction of the arrow in FIG. 14.

FIG. 16 is an expanded sectional view of an opening 43.

FIG. 17 is a diagram showing steps of attaching a lens frame 40.

FIG. 18 is a diagram cut by the XVIII-XVIII line where the image-capturing lens OU and IR cut filter F are attached to lens frame of FIG. 14, and viewed from the direction of an arrow.

FIG. 19 is a diagram showing a lens frame 40 viewed from the direction of an axis line.

FIG. 20 is a cross-sectional view showing a lens frame 40′ according to modification.

FIG. 21 is a diagram showing a lens frame 40′ according to modification viewed from the direction of an axis line.

FIG. 22 is a diagram showing a lens frame 40′ according to modification viewed from the direction of an axis line.

FIG. 23 is a perspective diagram of an image-capturing device 50 using an image-capturing lens and a lens frame 40′ according to this embodiment.

FIG. 24 is a diagram of the structure shown in FIG. 23 cut by XXIV-XXIV line, and viewed from the direction of the arrow in FIG. 23.

FIG. 25 is a diagram showing an image-capturing device 50 installed in a cell phone 100 as a mobile phone that is digital equipment.

FIG. 26 is a control block diagram of the cell phone 100.

FIG. 27 is a cross-sectional view showing a lens frame 40″ according to another modification provided with an image-capturing lens OU″ and a filter F.

FIG. 28 is a diagram showing an enlarged image of the portion indicated by the arrow XXVIII in FIG. 27.

FIG. 29 is a cross-sectional view showing a lens frame 40″ according to another modification provided with an image-capturing lens OU′″ and a filter F.

FIG. 30 is a diagram showing an enlarged image of the portion indicated by the arrow XXX in FIG. 29.

FIG. 31 is a cross-sectional view showing a lens frame 40″″ according to another modification provided with an image-capturing lens OU″, shielding member SH″″ and a filter F.

### BEST MODE FOR CARRYING OUT THE INVENTION

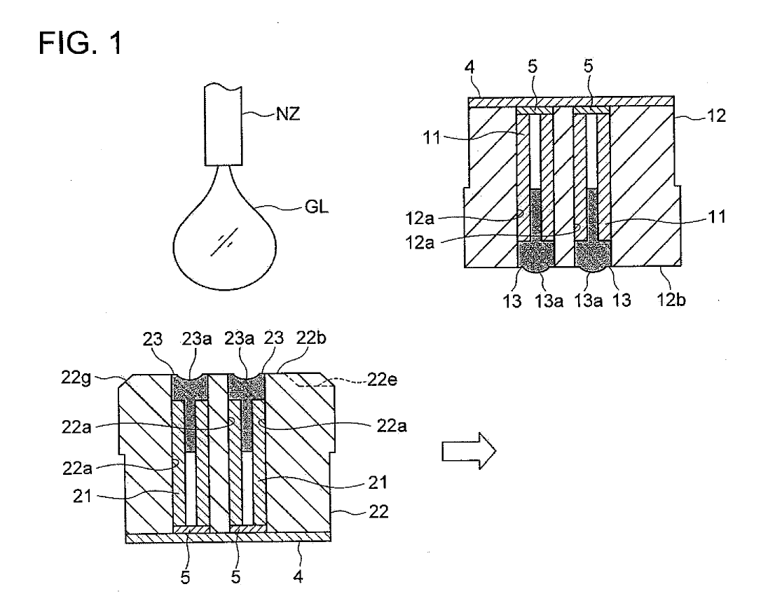

Hereafter, embodiments of the present invention are explained with reference to the drawings. At first, manufacture of an image-capturing lens is explained using FIGS. 1-3. In addition, 4 denotes bottom plates which cover the end portion of the upper mold 12 and the end portion of lower mold 22 and 5 denotes spacers for adjusting the amount of pushing out of cores 13 and 23. The lower mold 22 which is attached with the core support members 21, which are attached with the cores 23 to the upper end of the core support members 21, in four openings 22a in FIG. 1, respectively is located under the platinum nozzle NZ which communicates with the storage part (un-illustrating) storing heated and melted glass. Then droplets of the melted glass GL are dropped from the platinum nozzle NZ in a lump to a position which is equidistant from two or more molding surfaces on the upper surface 22b. In this state, since the viscosity of Glass GL is low, the glass GL which fell spreads on the upper surface 22b, and it also transfers the form of Slot 22e with sufficient accuracy while it advances easily into the transfer surface 23a of the core 23 and transfers the form.

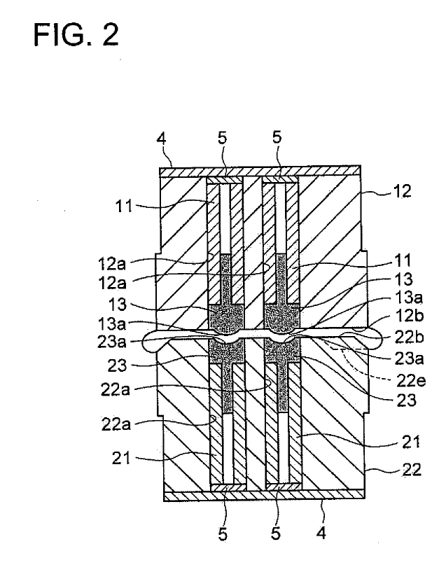

Subsequently, before Glass GL cools, the lower mold 22 is made to approach to the position where the lower mold 22 faces the upper mold 12 at below of the upper mold, the upper mold is attached with the core support members 11, which are attached with the cores 13 to the lower end of the core support members 11, in four openings 12a. Thus the lower mold 22 is adjusted to the upper mold 12 using a non-illustrated positioning guide. Furthermore, as shown in FIG. 2, molding is done by making upper mold 12 and Lower mold 22 approach. With these process, the form of the transfer surface 13a (here convex form) of a core 13 is transferred. In addition, since shallow circular step portion is formed in the circumference of the transfer side 13a, this is also transferred simultaneously. The undersurface 12b of the upper mold 12 and the upper surface 22b of lower mold 22 hold the glass so that they keep a predetermined distance and thus the glass GL is cooled at this time. The glass GL is solidified, where it turned to the circumference and covers taper parts 22g.

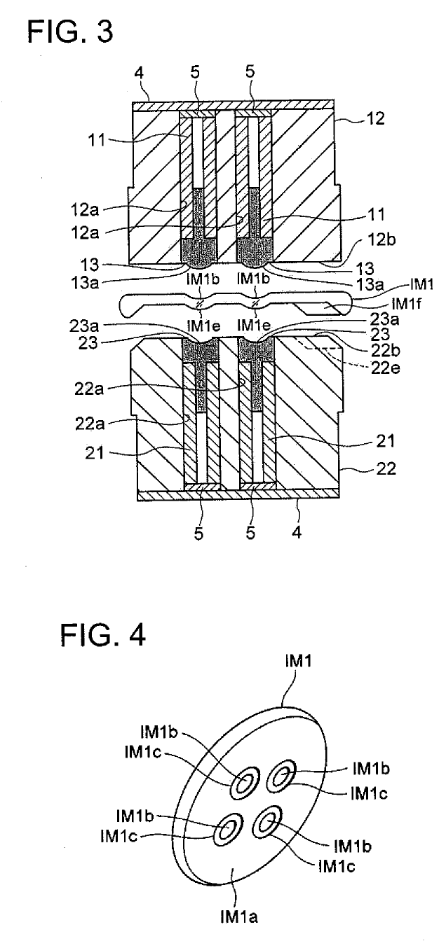

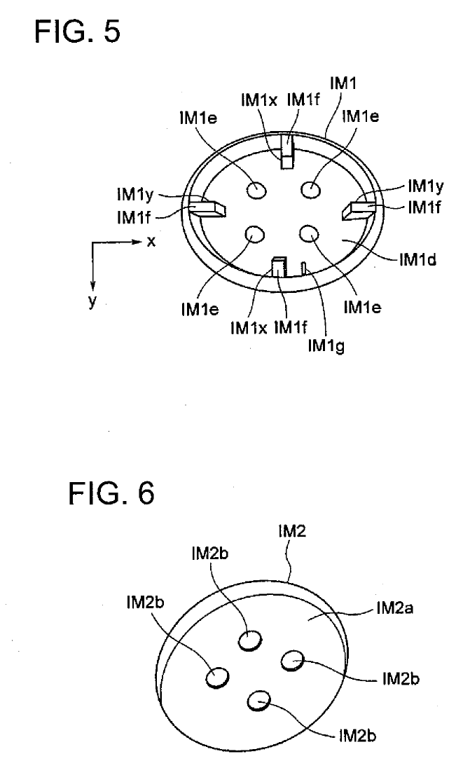

Then, upper mold 12 and lower mold 22 are separated as shown in FIG. 3, and a first glass lens array IM1 is formed by taking out glass GL. By another mold, a second glass lens array IM2 can be formed similarly. FIG. 4 is a perspective diagram on the front side of the first glass lens array IM1, and FIG. 5 is a perspective diagram on the back side.

As shown in FIGS. 4 and 5, the first glass lens array IM1 is disk form as a whole, and has a highly precise surface IM1a transfer molded by the undersurface 12b of the upper mold 12, four concave optical surfaces IM1b formed on the surface IM1a by transfer mold with the transfer surface 13a, and shallow circular slot IM1c transferred by circular step portion in the circumference. This circular slot IM1c is for accommodating the shielding member SH mentioned later.

Moreover, the first glass lens array IM1 has a highly precise back plane surface IM1d transfer molded by the undersurface 22b of the lower mold 22, four convex optical surfaces IM1e formed on the back surface IM1d by transfer mold with the transfer surface 23a, and convex portion IM1f transferred by the slot 22e. In addition, you may form simultaneously convex mark IM1g which shows a direction. The first lens part L1 is comprised of optical surface IM1b and optical surface IM1e. In addition, the convex part IM1f is parallel to the optical axis of the first lens part L1 and comprised of first reference surface part IM1x which faces the x direction, and second reference surface part IM1y which faces the y direction. The back surface IM1d constitutes the first inclination reference surface, and the first shift reference surface consists of the first reference surface part IM1x and the second reference surface part IM1y.

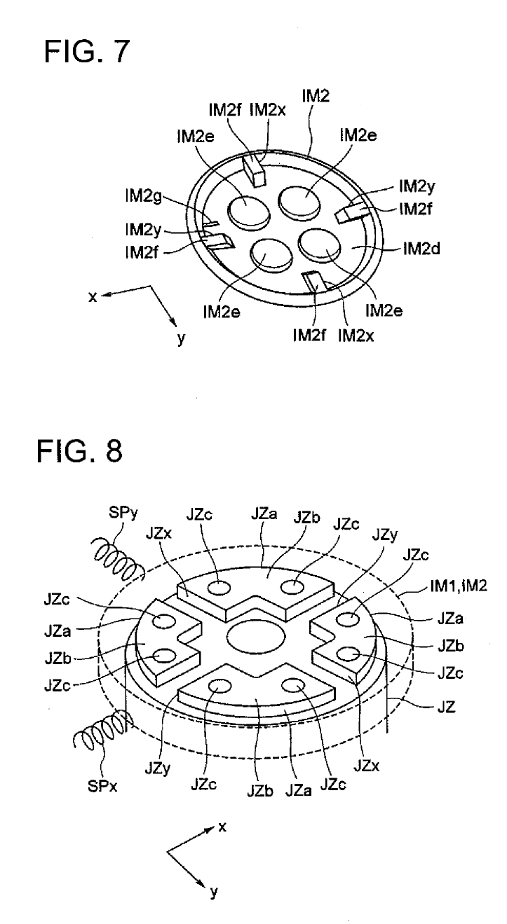

FIG. 6 is a perspective diagram on the front side of the second glass lens array IM2 transfer molded by another mold, and FIG. 7 is a perspective diagram on the back side. The second glass lens array IM2, fabricated like the first glass lens array, is disk form as a whole as shown in FIGS. 6 and 7. And the second glass lens array IM2 has a highly precise surface IM2a transfer molded by the non-illustrated mold and four concave optical surfaces IM2b transfer molded by the surface IM2a. In addition, although the shallow slot in the circumference of the optical surface IM2b used in order to accommodate the shielding member SH mentioned later is omitted in the second glass lens array IM2, you may prepare this.

Moreover, the second glass lens array IM2 has a highly precise back plane surface IM2d transfer molded by the non-illustrated mold, four convex optical surfaces IM2e formed on the back surface IM2d by transfer mold, and convex portion IM2f. You may form simultaneously a convex mark IM2g which shows a direction. The second lens part L2 is comprised of an optical surface IM2b and an optical surface IM2e. In addition, the convex part IM2f is parallel to the optical axis of the second lens part L2, and has a third reference surface part IM2x which faces the x direction, and a fourth reference surface part IM2y which faces they direction. Back surface IM2d constitutes the second inclination reference surface, and the third reference surface part IM2x and the fourth reference surface part IM2y constitute the second shift reference surface.

Next, the process for forming the third glass lens array IM3, in which the first glass lens array IM1 and the second glass lens array IM2 are pasted together, is explained. FIG. 8 is a figure showing a part of a jig JZ for holding the back of the first glass lens array IM1 or the second glass lens array IM2. In FIG. 8, the end surface of the jig JZ is incised in a cross shaped fashion. That is, four land parts JZa of uniform height are formed in the end surface of the jig JZ, and the upper surface JZb is a plane, and the suction hole JZc which communicates to non-illustrated vacuum source is formed in the upper surface JZb. The land part JZa has the reference holding surface JZx which face the x direction and the reference holding surface JZy which faces the y direction at the part incised in a cross shaped fashion. Furthermore, the jig JZ which holds the glass lens array has the spring SPx (simple illustration) for pressing the glass lens array to the x direction, and the spring SPy (simple illustration) for pressing the glass lens array to they direction.

Here, the second glass lens array IM2 is hold while resisting vertically. The upper surface JZb of the land part JZa is hit against the back surface IM2d of the second glass lens array IM2, making the top and bottom of the jig JZ reverse, and attracting air from the suction hole Mc. At this time, inclination of the second glass lens array IM2 to the jig JZ can be set up with sufficient accuracy because the upper surface JZb of the land part JZa of the jig JZ sticks to the back surface IM2d. Moreover, the spring SPx urges the reference holding surface JZx of the land part JZa to hit the third reference surface part IM2x and the spring SPy urges the reference holding surface JZy to hit the fourth reference surface part IM2y. At this time, the mark IM2g serves as an index with which the position of the third reference surface part IM2x and the fourth reference surface part IM2y shows either. Thereby, the xy direction of the second glass lens array IM2 to the jig JZ can be positioned with sufficient accuracy. Since the third reference surface part IM2x and the fourth reference surface part IM2y are formed in both sides of the lens part, respectively, they can perform highly precise positioning, using the elongated span effectively.

Similarly, back surface IM1d of the first glass lens array IM1 can be held with accuracy sufficient in the inclination direction and the xy direction by another jig JZ. Namely, inclination of the first glass lens array IM1 to the jig JZ can be set up with sufficient accuracy because the upper surface JZb of the land part JZa of the jig JZ sticks to back surface IM1d. Moreover, the spring SPx urges the reference holding surface JZx of the land part JZa to hit the first reference surface part IM1x and the spring SPy urges the reference holding surface JZy to hit the second reference surface part IM1y. At this time, the mark IM1g (first mark) serves as an index with which the position of the first reference surface part IM1x and the second reference surface part IM1y shows either. By deciding the relative position of two jigs JZ with sufficient accuracy by the above, positioning of the first glass lens array IM1 and the second glass lens array IM2 can be performed with sufficient accuracy.

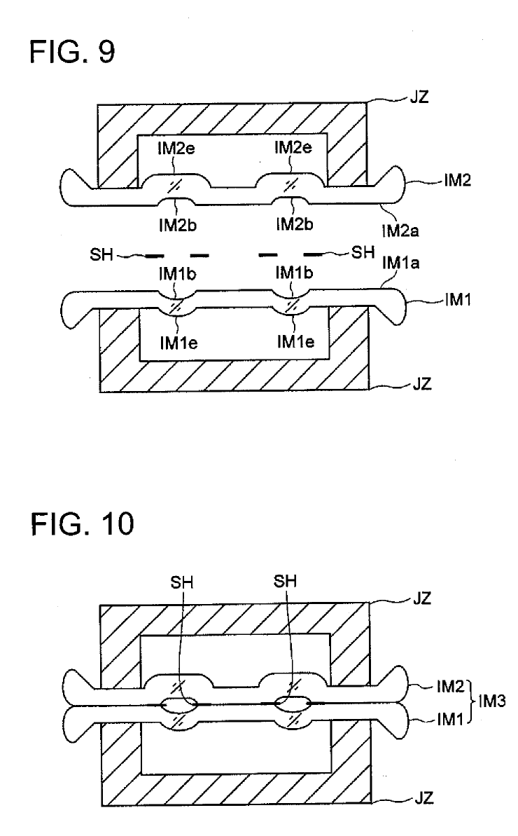

Furthermore, the surface IM1a of the first glass lens array IM1 held with sufficient accuracy by the jig JZ as mentioned above and the surface IM2a of the second glass lens array IM2 held with sufficient accuracy by another jig JZ are made to face as shown in FIG. 9, and four doughnut tabular shielding members SH are arranged among the surfaces. Then, after applying adhesion material to at least one surface IM1a and IM2a of the first glass lens array IM1 and the second glass lens array IM2, the surface IM1a and the IM2a are stuck as shown in FIG. 10, by making the jigs JZ to approach relatively and it waits for solidification of adhesives. The third glass lens array IM3 composed of the first glass lens array IM1 and the second glass lens array IM2 pasted together is formed by making it come to engage the shielding member SH to circular slot IM1c.

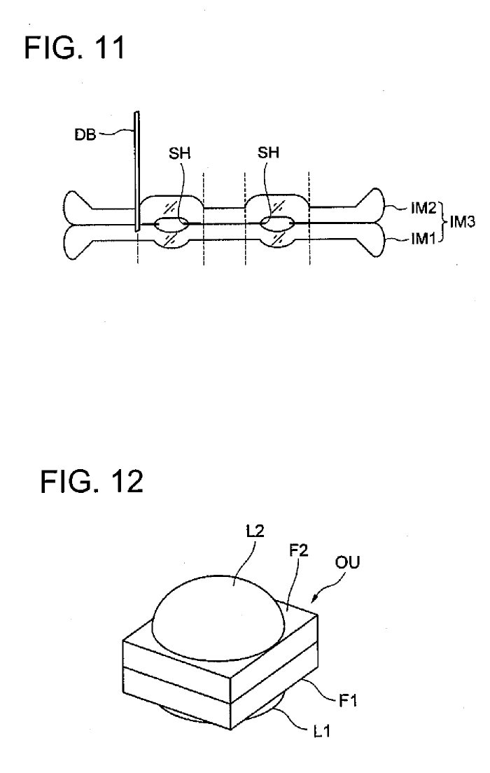

Then, the third glass lens array IM3 held at the lower jig JZ can be taken out by making suction of the upper jig JZ stop and releasing the upper jig JZ. Therefore, as shown in FIG. 11, with the dicing braid DB, the third glass lens array IM3 can be cut and the image-capturing lens OU as shown in FIG. 12 can be obtained. The image-capturing lens OU has the first lens S1 including optical surfaces S1 and S2, the second lens S2 including optical surfaces S3 and S4, the flange part F1 having a rectangle shape around the first lens L1 (composed of part of the surface IM1a and the surface IM1d of the first glass lens array IM1), the flange part F2 having a rectangle shape around the second lens L2 (composed of part of the surface IM2a and the surface IM2d of the second glass lens array IM2), and the shielding member SH arranged between the first lens L1 and the second lens L2.

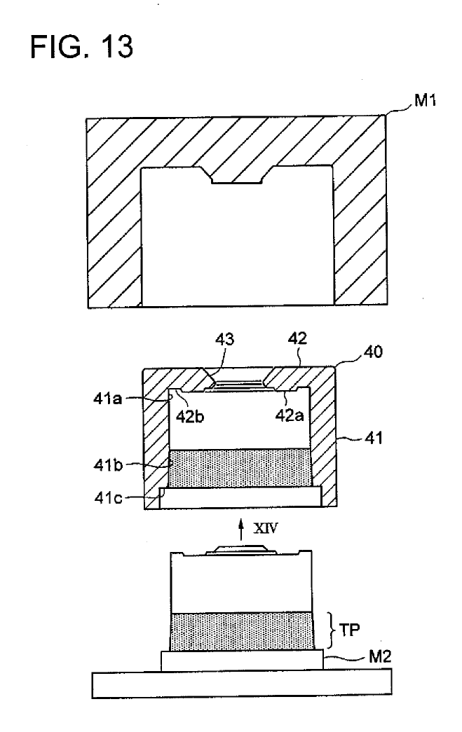

FIG. 13 is a diagram showing a step of molding a lens frame. The outer periphery surface of the lens frame 40 is formed of the rectangular tubular upper mold M1 and the outer periphery surface of the lens frame 40 is formed of the rectangular tubular lower mold M2. Here, as shown in FIG. 13, the tapered surface TP is formed in the lower part of the outer periphery surface of the lower model M2, and as for this tapered surface, the degree of surface roughness is getting worse by shot blast processing.

After clamping the upper model M1 and the lower model M2, the lens frame 40 is formed in the interior space by carrying out injection molding of the resin. Since the taper surface TP has a slope for extracting, molding is comparatively easy. The lens frame 40 has the peripheral wall 41, top wall 42 which closes the end of the peripheral wall 41, and the circular opening 43 formed in the center of top wall 42. The top wall 42 side of the inner periphery surface of the peripheral wall 41 is the surface 41a parallel to the axis line and the open end side of the inner periphery surface of the peripheral wall 41 is the taper surface 41b as a roughened surface. The surface form of the taper side TP of the lower model M2 is transferred by this taper surface 41b, and the degree of surface roughness is getting worse in it. The step portion 41c for fixing IR cut filter F to the lower end of the peripheral wall 41 is formed in the entire inner periphery. Thus, since the lens frame 40 is formed by one time molding using a mold, the distance between the contact portion 42a mentioned later and the end surface of the peripheral wall 41 and the position of the opening 43 relative to the peripheral wall 41 are formed with sufficient accuracy.

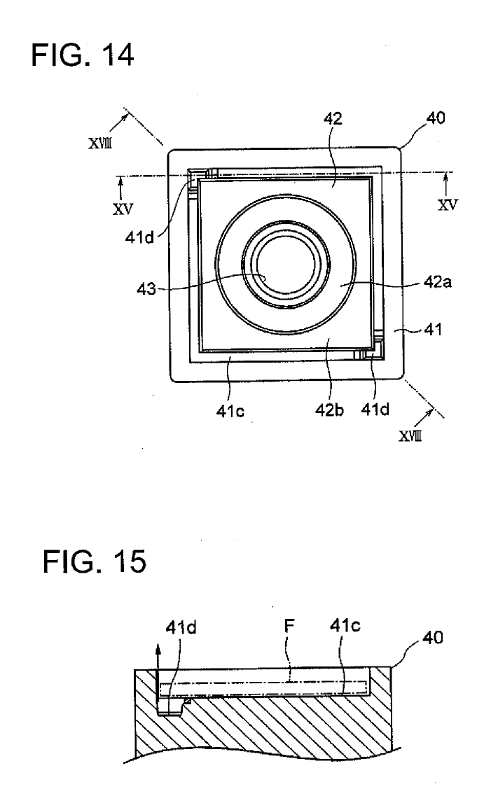

FIG. 14 is a diagram of the lens frame 40 viewed from the direction of the arrow XIV in FIG. 13. FIG. 15 is a diagram of the lens frame 40 cut by XV-XV line, and viewed from the direction of the arrow in FIG. 14. As shown in FIG. 14 and FIG. 15, the ring shaped contact portion 42a (the first contact portion) which rose one step, is formed in the inner surface of the top wail 42 of the lens frame 40 so as to surround the opening 43. Therefore, the area between this contact portion 42a and the peripheral wall 41 is the inner surface of the top wall 42 which fell by one step (the object side was approached) and being a plane with a circular inner surface in a rectangle, and this serves as the capture part 42b of adhesives. Furthermore, hollows 41d (it is also called communicating portion) as notches are formed on the diagonal line at the corners of the step portion 41c of the peripheral wall 41.

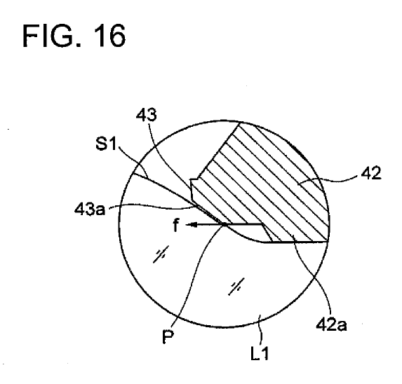

FIG. 16 is a sectional view expanding and showing the section of the opening 43 of the top wall 42 with a lens L1. In FIG. 16, the opening 43 which is the second contact portion adjoins the inside of the top wall 42, and has the taper surface 43a and the diameter of the taper surface 43a becomes small as it goes outside. The taper surface 43a has an inclination tighter than the surface S1 which is a convex lens surface of the lens L1 here, and on the section including the optical axis, the taper surface 43a touches by one point P to the surface S1 of the lens L1, when the surface S1 of the lens L1 is touched. And dimensions are controlled so that the inside diameter of the taper surface 43a which passes Point P becomes slightly larger (for example, greater by 1 μm to 10 μm) than the outer diameter of the surface S1 which passes Point P. In addition, although it is desirable for the inclination of the taper surface 43a to be tight rather than that of the surface S1 of the lens L1 on the direction including the optical axis, the inclination of the taper surface 43a may be loose as long as it touches by one point P to the surface S1 of the lens L1.

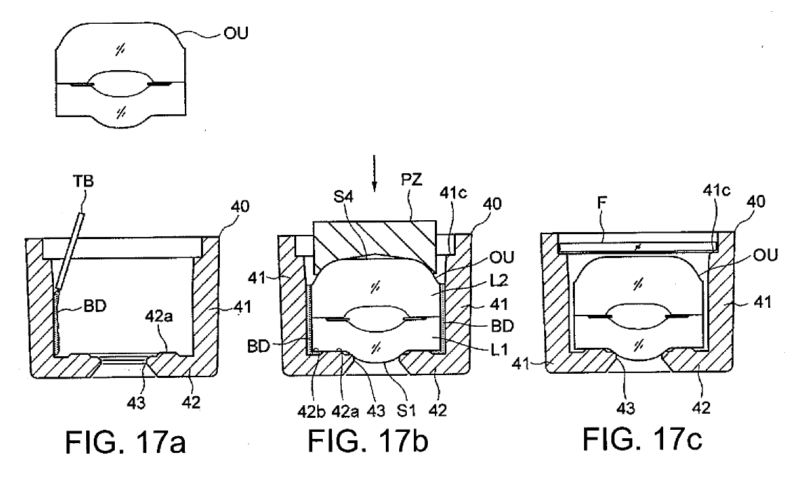

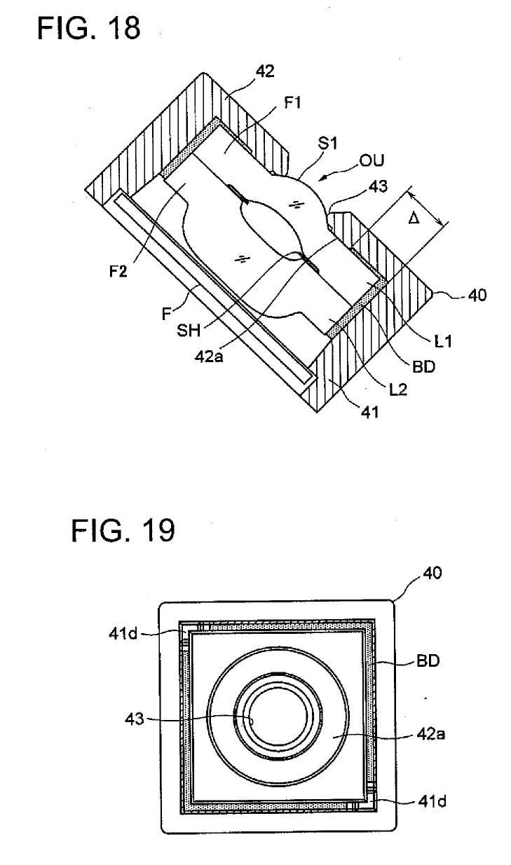

Next, the process for attaching the image-capturing lens OU and IR cut filter F which constitutes a part of the image-capturing lens unit to the lens frame 40 is explained. FIG. 17 is a diagram showing the step of attaching the lens frame 40. As first shown in FIG. 17 (a), the lens frame 40 is fixed so that the open end of the peripheral wall 41 may be directed upward, and adhesives BD are applied to the four corners (all the circumferences are sufficient) of the inner peripheral surface through tube-like adhesives application component TB. Then, as shown in FIG. 17 (b), the image-capturing lens OU is inserted and pushed from the upper part of the lens frame 40, and pushes the surface S4 of the image-capturing lens OU toward the top wall 42 of the lens frame 40 using the pressing jig PZ. Since the form the pressing jig PZ is designed so that the pressing jig PZ contacts only to the periphery of the surface S4, and does not contact the surface S4 near an optical axis, it is possible to press the image-capturing lens OU stably while suppressing inclination of the optical axis.

At this time, the surface S1 of the lens L1 of the image-capturing lens OU contacts the taper surface 43a of the opening 43 at first. With reference to FIG. 16, when the surface S1, which is a curved optical surface, of the lens L1 is pressed by the taper surface 43a, the surface S1 receives the reaction force f (here, only a radial ingredient is shown) will be received in the direction perpendicular to the optical axis. Then, by utilizing the reaction force f (namely, guide function of the taper surface 43a), the image-capturing lens OU is moved in the direction perpendicular to the optical axis and a positioning of the image-capturing lens OU and the lens frame 40 in a direction perpendicular to the optical axis can be carried out with sufficient accuracy within a managed small range of play (that is, within a range of play generated by the difference between the inside diameter of the taper surface 43a which passes Point P and the outer diameter of the surface S1 which passes Point 11. Finally, since the flange part F1 of the first lens L1 of the image-capturing lens OU contacts the contact portion 42a formed in top wall 42 of the lens frame 40 and becomes a state of reaching the bottom, a positioning of the image-capturing lens OU and the lens frame 40 in an optical axis direction can be carried out with sufficient accuracy. In addition, in a case where the displacement between the optical axis of the image-capturing lens OU and the optical axis of the opening 43 is within a managed small range of play, the surface S1 of the lens L1 of the image-capturing lens OU does not hit the taper surface 43a of the opening 43 when inserting the image-capturing lens OU from the above of the lens frame 40.

The image-capturing lens OU scratches adhesives BD with the outer periphery surface of the flange part while advancing inside the lens frame 40. Since there is a comparatively big gap between the flange part F1, F2 of the image-capturing lens OU, and the peripheral wall 41 of the lens frame 40 according to the present embodiment, it is possible to fix the image-capturing lens OU and the lens frame 40 firmly by filling up the gap with adhesives BD. Moreover, even when the application amount of the adhesives BD is somewhat more than a predetermined quantity, the capturing part 42b formed between the contact portion 42a and the peripheral wall 41 works as adhesive reservoir and can capture the adhesive so that adhesives BD may not run aground to this contact portion 42a, or may not run over the contact portion 42a and pollute the optical surface.

In addition, both of the flange part of the image-capturing lens OU and the lens frame 40 are in a rectangular tubular shape. Therefor; the gap Δ in the directions of a diagonal in the lens frame 40 is comparatively large, and it is advantageous to capture the adhesives BD. The pressing jig PZ continues pressing the image-capturing lens OU until the adhesives BD solidified.

Then, as shown in FIG. 17 (c), IR cut filter F which is a rectangle parallel plate as an optical element is pasted up on the step portion 41c of the peripheral wall 41 of the lens frame 40. But, as shown in FIG. 19, the adhesive BD so as to avoid 41d of hollows on a diagonal line. At a later process, the image-capturing element is installed to the lens frame 40 by passing through a reflow furnace with a non-illustrated substrate. In this process, even if the air inside the heated lens frame 40 expands, destruction of lens frame 40 can be controlled, because the expanded air passes through 41d of hollows and escapes outside as the arrow of FIG. 15 shows. Moreover, since two hollows 41d are prepared on the diagonal line, even if IR cut filter F inclines toward one side at the time of attachment, the air can pass through the remaining hollow 41d. According to the present embodiment, even in a case where all around of the flange part is sealed by the adhesive so as to keep adhesive strength of the image-capturing lens, the escape of air can be secured. In addition, you may make the hollows 41d on not only a diagonal line top but also on a part of a side facing to the step portion 41c.

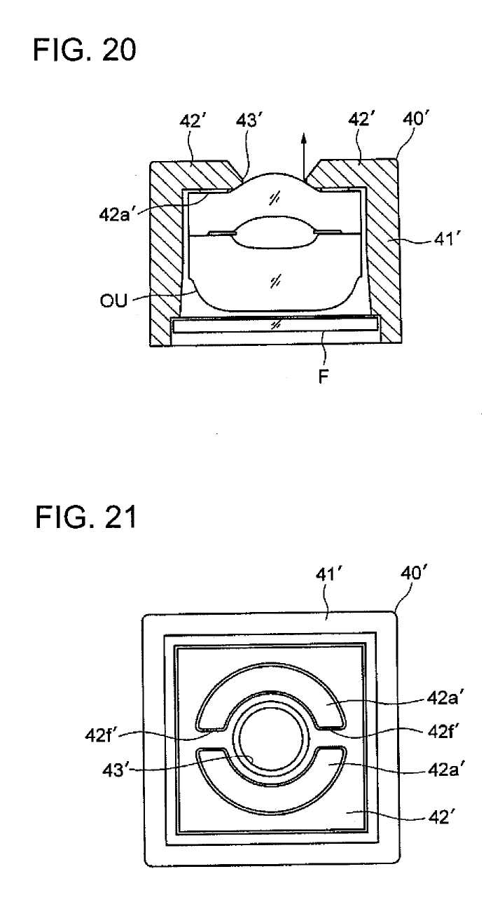

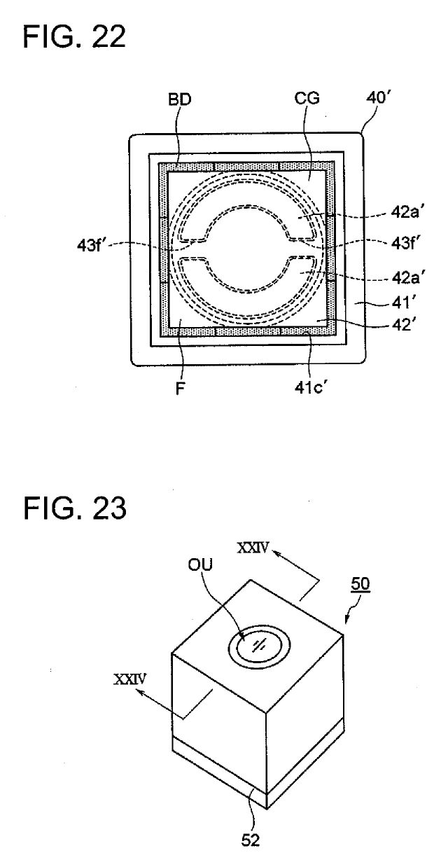

FIG. 20 is a cross-sectional view showing lens frame 40′ according to modification with the image-capturing lens OU and the filter F. And FIGS. 21 and 22 are diagrams showing a lens frame 40′ according to modification from the side of the peripheral wall 41′. In the lens frame 40′ according to the modification, the contact portion 42a′ established in top wall 42′ is notched radially and forms the communicating channel 42f′ (it is also called communicating portion). Instead, the hollow is not formed in step portion 41c′ of the peripheral wall 41′. In the case of this modification, even if the flange part of the image-capturing lens OU contacts to the contact portion 42e, the internal and external air can communicate through the communicating channel 42f. Therefore, even if the air inside the heated lens frame 40 expands at the time of passing through the furnace, destruction of lens frame 40 can be controlled, because expanded air escapes outside through the communicating channel 42f as the arrow of FIG. 20 shows. According to the present embodiment, adhesives BD can be applied to all the circumferences of step portion 41c′ in order to paste up IR cut filter F as shown in FIG. 22, and therefore application work becomes easier.

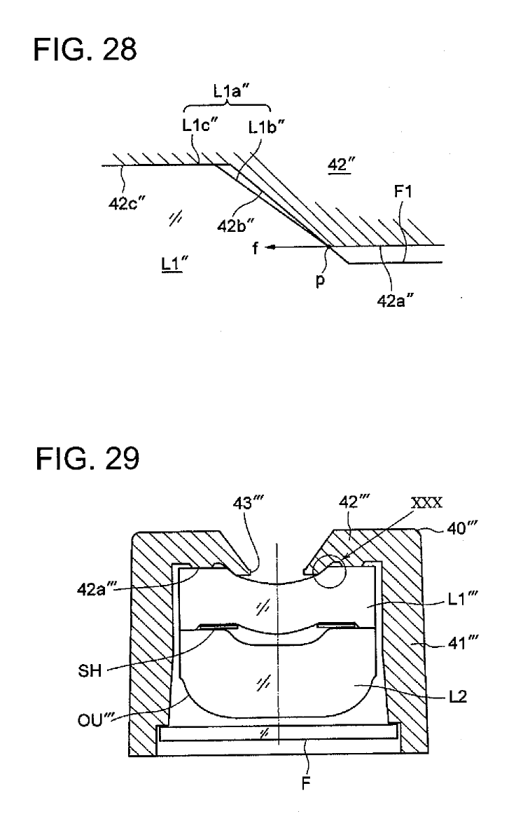

FIG. 27 is a cross-sectional view showing the lens frame 40″ according to another modification with image-capturing lens OU″ and Filter F, and FIG. 28 is a diagram showing an enlarged image of the portion indicated by the arrow XXVIII of FIG. 27. In FIG. 27 and FIG. 28, the ring-shaped contact portion 42a″ formed on the inside of the top wall 42″ of lens frame 40″ has the lens frame taper surface 42b″ (the second contact portion) on the side facing the optical axis and the diameter of the lens frame taper surface 42b″ becomes small as it goes the side of the opening 43″. On the other hand, the first lens L1″ of image-capturing lens OU″ has a ring-shaped portion L1a″ projected in the direction of an optical axis molded by the same mold as the mold which molded the optical surface, in a radial outward direction of the concave optical surface of the on the side of the opening 43″.

As shown in FIG. 28, the ring-shaped portion L1a″ forms the end surface L1c″ perpendicular to the optical axis and the lens frame taper surface L1b″ which faces the lens frame taper surface 42b″ and the diameter of the lens taper surf frame ace L1b″ becomes small as it goes the side of the opening 43″. The lens frame taper surface L1b″ is a part of the inclined surface formed in the flange part F1 of the first lens L1″ concentrically with respect to the optical axis. The lens frame taper surface 42b″ has an inclination tighter than lens taper surface L1b″ of the first lens L1″ here, and on the cross-section including the optical axis, when the lens frame taper surface 42b″ is touched with the lens taper surface L1b″, the lens frame taper surface 42b″ touches by one point P of its lower end or its neighborhood. And dimensions are controlled so that the inner diameter of the lens frame taper surface 42b″ which passes Point P becomes more slightly large (for example, greater by 1 μm to 10 μm) than the outer diameter of the lens taper surface L1b″ which passes Point P. In addition, although it is desirable far the lens frame taper surface 42b″ that the inclination of the lens frame taper surface 42b″ to be tight rather than that of the lens taper surface L1b″ on the cross-section including the optical axis, the inclination may be loose as long as it touches by one point P to lens taper surface L1b″.

When attaching the image-capturing lens OU″ to the lens frame 40″, the lens taper surface L1b″ hits the lens frame taper surface 42b″ by inserting from the side of the first lens L1″ of the lens frame 40″. With reference to FIG. 28, when the lens taper surface L1b″ is pressed by the lens frame taper surface 42b″, the lens taper surface L1b″ receives the reaction force fin the direction perpendicular to the optical axis. Then, by utilizing the reaction force f (namely, guide function of the lens frame taper surface 42b″), the image-capturing lens OU″ is moved in the direction perpendicular to the optical axis and a positioning of the image-capturing lens OU″ and the lens frame 40″ in a direction perpendicular to the optical axis can be carried out with sufficient accuracy within a managed small range of play (that is, within a range of play generated by the difference between the inside diameter of the lens frame taper surface 42b″ which passes Point P and the outer diameter of the lens taper surface L1b″ which passes Point P). Finally, since the end surface L1c″ of the first lens L″1 of the image-capturing lens OU″ contacts the inner surface 42c″ (first contact portion) of the top wall 42 of the lens frame 40 at outside in a radial direction of the opening 43″, and becomes a state of reaching the bottom, a positioning of the image-capturing lens OU″ and the lens frame 40″ in an optical axis direction can be carried out with sufficient accuracy.

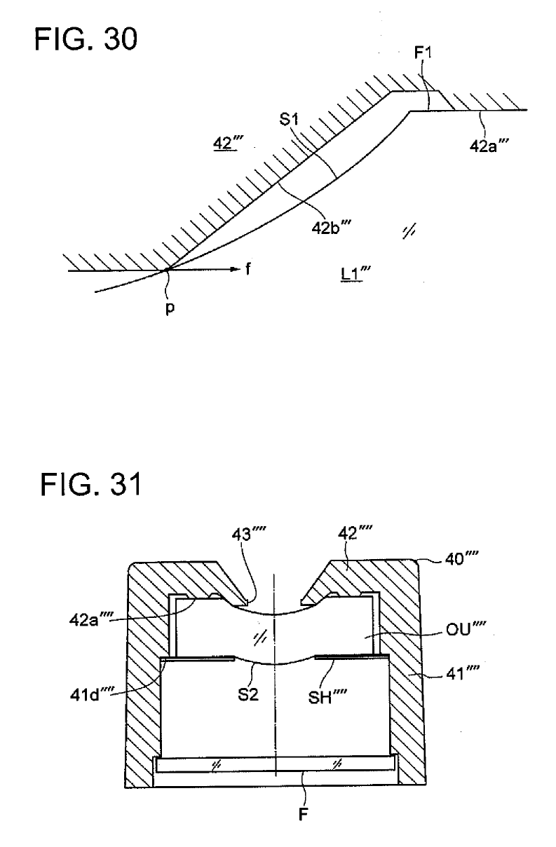

FIG. 29 is a cross-sectional view showing a lens frame 40′″ according to another modification with image-capturing lens OU′″ and filter F, and FIG. 30 is a diagram showing an enlarged image of the portion indicated by the arrow XXX of FIG. 29. In FIG. 29 and FIG. 30, the lens frame taper surface 421f (second contact portion) facing radially outward is formed on a side nearer to the opening 43′″ than the ring-shape contact portion 42a′″ (first contact portion) in the inner surface of the top wall 42′″ of the lens frame 40′″. The lens frame taper surface 42b′″ has a shape in which the diameter of the lens frame taper surface 42b′″ becomes larger as it goes the side of the contact portion 42a′″. On the other hand, the first lens L1′″ of the image-capturing lens OU′″ has a concave surface S1 which extends to the outer side of the opening 43′″. The inclination of the lens taper surface 42b′″ is tighter than the surface S1 of the first lens L1′″ at least near the contact point, and on the cross-section including the optical axis, when the lens frame taper surface 42b′″ is touched with the surface S1 of the first lens L1′″, the lens frame taper surface 42b′″ touches by one point P of its lower end or its neighborhood. And dimensions are controlled so that the outer diameter of the lens frame taper surface 42b′″ which passes Point P becomes more slightly small (for example, smaller by 1 μm to 10 μm) than the inner diameter of the surface S1 which passes Point P. In addition, although it is desirable for the lens frame taper surface 42b′″ that the inclination of the lens frame taper surface 42b′″ to be tight rather than that of the surface S1 of the first lens L1′″ on the cross-section including the optical axis, the shape of the lens frame taper surface 42b′″ may be an shape as long as it touches by one point P to the surface S1. And, the contact surface which contacts the lens frame taper surface 42b′″ is no limited to the surface S1 provided outside of the effective diameter where the light flux to form an image on the image-capturing element, it may be the taper surface extending outside of the surface S1 and transfer molded simultaneously with the surface S1.

When attaching the image-capturing lens OU′″ to the lens frame 40′″, the surface S1 of the first lens L1′″ hits the lens frame taper surface 42b′″ by inserting from the side of the first lens L1″ of the lens frame 40′″. With reference to FIG. 30, when the surface S1 is pressed by the lens frame taper surface 42b′″, the surface S1 receives the reaction force fin the direction perpendicular to the optical axis. Then, by utilizing the reaction force f (namely, guide function of the lens frame taper surface 42b′″), the image-capturing lens OU′″ is moved in the direction perpendicular to the optical axis and a positioning of the image-capturing lens OU′″ and the lens frame 40′″ in a direction perpendicular to the optical axis can be carried out with sufficient accuracy within a managed small range of play (that is, within a range of play generated by the difference between the outer diameter of the lens frame taper surface 42b′″ which passes Point P and the inner diameter of the surface S1 which passes Point P). Finally, since the upper surface of the flange par F1 of the first lens L1′″ of the first lens of the image-capturing lens OU′″ contacts the contact portion 42a′″ of the top wall 42′″ of the lens frame 40′″, and becomes a state of reaching the bottom, a positioning of the image-capturing lens OU′″ and the lens frame 40′″ in an optical axis direction can be carried out with sufficient accuracy.

FIG. 31 is a cross-sectional view showing a lens frame 40″″ according to another modification provided with an image-capturing lens OU″″, shielding member SH″″, and a filter F. In this modification, comparing with the configuration shown in FIG. 29, the image-capturing lens OU″″ consists of single lenses, and outer shape of the shielding member SH″″ is made into the square form corresponding to the inner shape of the lens frame 40″. Moreover, corresponding to this, at the inner circumference surface of the peripheral wall 41″″ of the lens frame 40″″″, the diameter becomes larger as it goes to a predetermined position from the image-capturing element side (the lower side in FIG. 31), and a step portion 41d″″ is formed here.

As described above, after positioning the image-capturing lens OU″″ against the lens frame 40″″, inserting the shielding member SH″″ from the image-capturing element side then while pressing the circumference of the surface S2 of the image-capturing lens OU″″, it is possible to fix the outer periphery to the step portion 41d″″ of the peripheral wall 41″″. Moreover, it is also possible that after fitting the shielding member SH″″ to the image-capturing lens OU″″, while pressing the shielding member SH″″, the image-capturing lens OU″″ is inserted into the lens frame 40″″ and positioning in a direction perpendicular to the optical axis and an optical axis direction is conducted, and then fix the shielding member SH″″ to the step portion 41d″″ of the peripheral wall 41″″. This configuration of the modification can be combined with the abovementioned example and modifications.

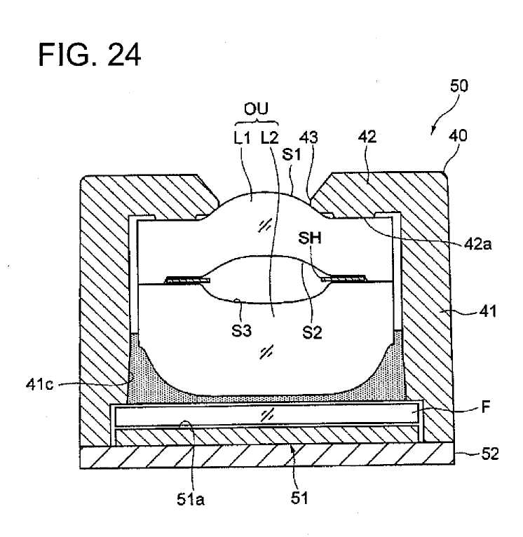

FIG. 23 is a perspective diagram of the imaging-capturing device 50 which uses the image-capturing lens unit which consists of the image-capturing lenses and lens frames according to this embodiment, and FIG. 24 is a diagram of the structure shown in FIG. 23 cut by XXIV-XXIV line, and viewed from the direction of the arrow in FIG. 23. As shown in FIG. 24, the imaging-capturing device 50 is provided with the CMOS type image sensor 51 as a solid-state image sensing device with which the image-capturing device 50 has the photoelectric conversion part 51a, the image-capturing lens OU which introduces a photographic subject image to the photoelectric conversion part 51a of this image sensor 51, and the substrate 52 which has a terminal for external connection (un-illustrated) which sends and receives that electric signal while holding an image sensor 51, and these are formed in one.

In the image sensor 51, the photoelectric conversion part 51a as a photo receiving part in which pixels (photoelectric conversion elements) are arranged in two dimensions is formed in the center of the plane on a photo receiving side and the image sensor is connected to the non-illustrated signal-processing circuit.

This signal-processing circuit consists of a drive circuit part which drives each pixel one by one and obtains a signal electric charge, an A/D conversion part which changes each signal electric charge into a digital signal, a signal-processing part which generates an image signal output using this digital signal, etc. Moreover, near the outer edge of the plane of photo receiving side of the image sensor 51, many pads (illustration omitted) are arranged and it connects with the substrate 52 through the non-illustrated wire. The image sensor 51 changes the signal electric charge from the photoelectric conversion part 51a into image signals, such as a digital YUV signal, etc., and outputs it to the predetermined circuit on a substrate 52 through a wire (un-illustrated). Here, Y represents a brightness signal, U (=R−Y) represents the color difference signal between red and the brightness signal, and V (=B−Y) represents the color difference signals between blue and the brightness signal. In addition, a solid-state image sensing device is not limited to an above-mentioned CMOS type image sensor, and may use other things, such as CCD.

The substrate 52 which supports the image sensor 51 is communicably connected to the image sensor 51 by non-illustrated wiring.

A substrate 52 is connected with an external circuit (for example, control circuit which the higher rank equipment of the personal digital assistant which mounted the image-capturing device has) through the non-illustrated terminal for external connection. It makes it possible to receive the voltage for driving an image sensor 51, and supply of a clock signal from an external circuit, and to output a digital YUV signal to an external circuit.

The upper part of an image sensor 51 is sealed with the cover glass which is not illustrated, and IR cut filter F is arranged between the second lens L2 and the cover glass in the upper part. A rectangular tubular lens frame 40 has an opening at its lower portion. But the upper portion is covered by top wall 42. The opening 43 is formed in the center of the top wall 42. The image-capturing lens OU is arranged in the lens frame 40.

The image-capturing lens OU has in order from the object side (it is the upper part in FIG. 24), the aperture diaphragm on which the opening edge of a lens frame functions, the first lens part L1, the shielding member SH which shades unnecessary light, and the second lens part L2. As mentioned above, since the first lens part L1 and the second lens part L2 are glass, they are excellent in the optical characteristic. In the present embodiment, by contacting the flange part of the image-capturing lens OU and this contact portion 42a of the lens frame 40, positioning of the image-capturing lens OU in the optical direction can be realized, and by contacting the part of the perimeter of the optical surface S1 of the image-capturing lens OU and the taper surface 4a of the opening 43 of the lens frame 40, positioning of the image-capturing lens OU in the direction perpendicular to the optical axis can be realized. Therefore, positioning of the photo receiving surface of the image sensor 51 to the focal point of the image-capturing lens OU can be achieved only by placing the lens frame on the substrate 52. Further, as the taper surface 41b of the lens frame 40 is a roughened surface and formed in the area at least that can cover the surface S4 of the image-capturing lens L2 of an image side, it is possible to effectively suppress a ghost. In addition, roughened surface may be providedin the whole inner circumference surface of the peripheral wall 41.

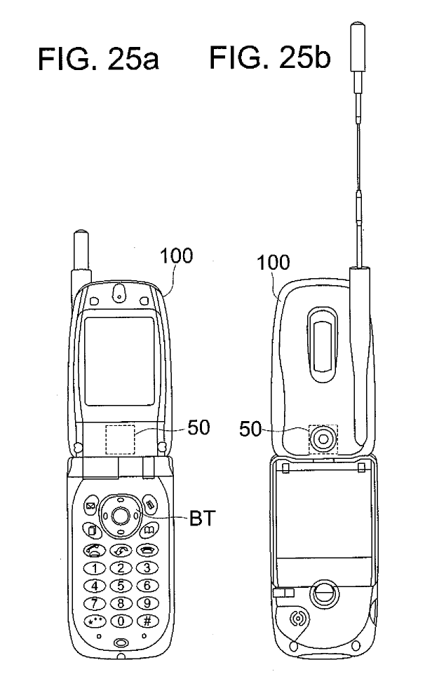

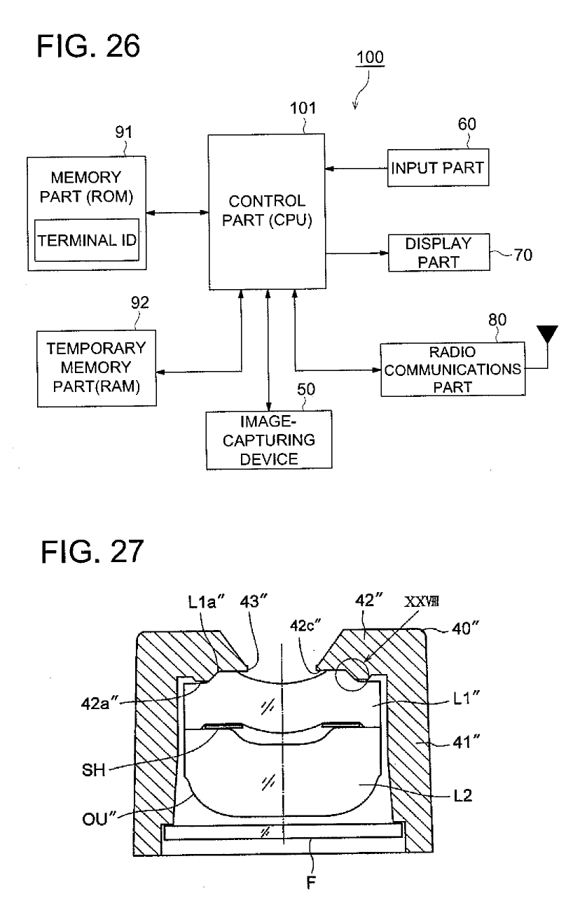

Next, the use mode of the image-capturing device 50 mentioned above is explained. FIG. 25 is a diagram showing an image-capturing device 50 installed in a cell phone 100 as a mobile phone that is digital equipment. And, FIG. 26 is a control block diagram of the cell phone 100.

In the image-capturing device 50, the end surface on the object side of the image-capturing lens OU is arranged on a back (let the liquid-crystal-display part side be the front) of the cell phone 100, for example, and provide so that it may become a position which corresponds under the liquid-crystal-display part.

The terminal for external connection of the image-capturing device 50 (un-illustrating) is connected with the control part 101 of the cell phone 100, and outputs image signals, such as a brightness signal and a color difference signal, to the control part 101 side.

On the other hand, as shown in FIG. 26, the cell phone 100 is provided with the control part (CPU) 101 which executes the program according to each processing, the input part 60 for carrying out the instruction input of the number etc. by a key, the display part 70 which displays the photographed picture, an image, etc., the Radio Communication part 80 for realizing variety-of-information communication between external servers, the memory part (ROM) 91 which has memorized many required data of the system program of the portable telephone 100, various processing programs, terminal ID, etc., and the memory part (RAM) 92 which is used as workspace which stores temporarily the various processing programs executed by the control part 101, data, processing data, or the image pick-up data based on the image-capturing device 50.

If the photography person who holds the cell phone 100 turns the image-capturing lens OU of the image-capturing device 50 to a photographic subject, the image signal of a still picture or an animation will be taken into an image sensor 51. At a desired photo opportunity, release will be performed by a photographer by pushing the button BT shown in FIG. 25, and an image signal will be taken into the image-capturing device 50. It is transmitted to the control system of the above-mentioned cell phone 100, and the memory part 92 will memorize, or the image signal inputted from the image-capturing device 50 will be displayed in the display part 70, and will be further transmitted outside as image information through the Radio Communications part 80.

### INDUSTRIAL AVAILABILITY

The present invention is not limited to the embodiment described in the specification and it is clear that other embodiments and modifications are included in the present invention. For example, although the glass lens is used with the above-mentioned embodiment, the resin lens obtained by molding in the shape of an array and cutting by resin and the lens which formed the lens part by curable resin on the glass substrate are sufficient. Although the image-capturing lens was used as the two lens type or the single lens, it could consist of three or more lenses. Furthermore, although UV curable adhesives and heat hardening adhesives are preferably used as adhesives, temporary adhesion may be carried out, for example with UV curable adhesives, and heat hardening adhesives may perform this adhesion after that.

### DESCRIPTION OF THE SYMBOLS

40, 40′, 40″, 40′″ and 40″″ Lens frame
41, 41′ and 41″″ Peripheral wall
41a approximately parallel plane
41b Taper surface
41c Step portion
41d Hollow
42 top wall
42a Contact portion
42b Capture part
42b″ Lens frame taper surface
42f″ Communicating channel
43 Opening
43a Taper surface
50 Image-capturing device
51 Image Sensor
51a Photoelectric conversion part
52 Substrate
60 Input Part
70 Display Part
80 Radio Communications part
92 Memory Part
100 Cell phone
101 Control Part
BD Adhesives
BT Button
F IR cut filter
F1, F2 Flange part
L1 Lens part
L2 Lens part
M1 Upper mold
M2 Lower mold
OU Image-capturing lens
PZ pressing jig
S1-S4 Optical surface
SH Shielding member
TB Tube
TP Taper surface

1. An image-capturing lens unit comprising:
an image-capturing lens; and
a lens frame which holds the image-capturing lens,
wherein the image-capturing lens includes an optical surface and a flange part formed on a periphery of the optical surface, at least a part of a circumference of the flange part has been cut; and
the lens frame includes a first contact portion for positioning in an optical axis direction of the image-capturing lens by contacting to the flange part, and a second contact portion for positioning in a direction intersecting the optical axis by contacting to a part of a whole circumference of the optical surface or a part of a whole circumference of an inclined surface formed concentrically with respect to the optical axis on the flange part.

2. The image-capturing lens unit of claim 1, wherein the flange part of the image-capturing lens has a rectangle shape.

3. The image-capturing lens unit of claim 1, wherein a roughened surface is formed on at least a part of an inner periphery surface of the lens frame.

4. The image-capturing lens unit of claim 3, the lens frame is formed by molding using a mold and a transfer surface of the mold for transferring the roughened surface has been subjected to a blast processing.

5. The image-capturing lens unit of claim 1, wherein the lens frame is formed integrally of a peripheral wall and a top wall which covers one end surface of the peripheral wall; the image-capturing lens and the lens frame are formed to be fixed by using an adhesive pasted on the peripheral wall; and a capturing part for capturing an adhesive is provided on the top wall.

6. The image-capturing lens unit of claim 1, wherein the lens frame includes a communicating portion to enable an air to pass between an inside and an outside of the lens frame.

7. The image-capturing lens unit of claim 6, wherein the communicating portion comprises a notch provided on a site of the lens frame to which an optical element to be provided on a side where an image-capturing element of the image-capturing lens is provided is fixed.

8. The image-capturing lens unit of claim 7, wherein the optical element has a rectangle shape and a pair of the notches is provided on two places in a diagonal direction of the optical element.

9. The image-capturing lens unit of claim 6, wherein the communicating portion is a notch formed on the contact portion which contacts the flange part in the optical axis direction.

10. The image-capturing lens unit of claim 1, wherein the image-capturing lens is attached to the lens frame through a shielding member.
